(19) United States
(12) Patent Application Publication
(10) Pub. No.: US 2021/0285451 A1
(43) Pub. Date: Sep. 16, 2021

(54) Liquid Hydrocarbon Transfer System And Assembly

(71) Applicant: Kenneth R. Soerries, Milford, MI (US)

(72) Inventor: Kenneth R. Soerries, Milford, MI (US)

(21) Appl. No.: 16/149,678

(22) Filed: Oct. 2, 2018

(51) Int. Cl. F04D 13/04; F04B 17/00

(52) U.S. Cl. CPC F04D 13/04; F04B 17/00

(57) ABSTRACT

A system for pumping hydrocarbon bulk fluids includes an air-driven rotary or reciprocating positive displacement pump in fluid communication with a tank containing the hydrocarbon bulk fluid. The pump contains an inlet and an outlet. A filter or strainer is contained within the inlet for removing debris from the bulk fluid. An oiler is provided for injecting an oil and/or antifreeze mixture into an air stream provided to the air-driven positive displacement pump. A method of pumping a bulk fluid such as a hydrocarbon fuel, from one tank to another, is also presented.

### CROSS-REFERENCE TO RELATED APPLICATIONS

### Technical Field

The present invention relates to a liquid hydrocarbon transfer assembly that moves the liquid from one tank to another in a multi-storage facility. It will be appreciated that the fluid transferred may be a hydrocarbon or a fuel, as in a preferred embodiment, or it may be another bulk fluid as determined by the customer.

### BACKGROUND OF THE INVENTION

Liquid hydrocarbons are refined from crude oils. These hydrocarbons include kerosene, diesel fuel for compressions combustion engines, aviation fuels, heavy fuels for steam power plants, fuels for turbine engines, and fuels for gasoline engines with spark ignition systems. Each of these fuels is refined for a specific use. There are typically different grades for each of these hydrocarbons. Some of the hydrocarbons change depending on the time of year and the location in the world. Additives may be mixed with the hydrocarbons, if desired.

The liquid hydrocarbons are stored in large storage tanks until they are needed for their intended use. The large storage tanks are located in what are known as tank farms. These tank farms are often located in areas where there is a demand for the hydrocarbons that are contained within the tanks.

Storage tanks in a tank farm are separated from each other and are typically encircled by a berm. The berm may contain any leak from the tank or tanks that they surround. Hydrocarbons are combustible. In the event of a fire, the berms and the space between the storage tanks are designed for safety, and to keep fires from spreading from one storage tank to an adjacent tank.

The storage tanks have a horizontal steel floor and cylindrical walls that are vertical. A recessed area, or sump, is typically provided between the cylinder wall and the horizontal floor. This recessed area or sump forms a trough that holds some liquid and accommodates some movement between the horizontal floor and the cylindrical walls. The movement is due to temperature changes as well as changes in the weight of liquid contained in the storage tank.

A tank roof is supported by the liquid stored inside the tank. As liquid fuel is removed from the storage tank, the tank roof moves downward. Pumping fuel into the storage tank forces the tank roof upward. Seals are provided between the flat roof and the inside surface of the cylindrical wall.

Downward movement of the tank roof is limited. Limiting downward movement prevents interference between the roof seals and pipe connections in the cylindrical walls for passage of liquid into and out of the storage tank. Limiting downward movement of the tank roof also facilitates entry into an empty tank through an unsealed opening for inspection and cleaning if necessary.

A need to empty one storage tank for receipt of a different hydrocarbon occurs frequently. The tank farm may, for example, have two storage tanks with the same fuel that are partially empty. By transferring the fuel from a first tank to a second tank, the first tank may be emptied and free to receive a different fuel.

One current system for moving hydrocarbon from a storage tank includes the use of a vehicle with a vacuum system and a pressure vessel. The pressure vessel is connected to the storage tank to be filled and emptied by a hose. The vacuum system draws air from the pressure vessel as it draws fuel into the pressure vessel. The air evacuated from the pressure vessel tends to collect vapors liberated or volatized from the liquid hydrocarbon. The air discharged from the vacuum vessel is discharged into the immediately surrounding atmosphere and oftentimes includes hydrocarbon vapors. As a result, the hydrocarbon vapors may sometimes collect within the berm of the tank being evacuated. For example, the typical pumping system as currently known has a diesel engine that drives the vacuum system. On a day with minimal wind, the diesel engine pulls in the resultant fuel vapors from the atmosphere and because of the resident fuel vapors, may continue to run after the engine is turned off. It is believed that the hydrocarbon vapors that collect in the surrounding area, therefore, represent a safety concern from an operations standpoint, in addition to the detriment of releasing hydrocarbons to the atmosphere.

After the pressure vessel is filled, the system is disconnected from the stationary storage tank and the vacuum truck is moved to a fuel discharge station, or a receiving tank. The current system is therefore relatively expensive to purchase and operate. The current system is also relatively very slow. When tanks sit idle due to lengthy pumping times, the owner of the tank oftentimes must pay tax or fees with respect to the tank even if the tank is idle.

Diaphragm pumps have been used to transfer oil from tank to tank. One disadvantage is that the diaphragm pumps freeze up in colder weather, and as they freeze, pumping is either stopped or substantially slowed. In essence, the moisture in the air driving the pump produces ice at the diaphragm, and therefore the pumping ceases or is markedly slowed. Furthermore, certain diaphragm pumping systems typically pump relatively slowly and therefore, pumping times are extended thereby increasing the operating costs to the operator/owner of the tanks.

One additional challenge to using other types of pumps such as alternative rotary displacement pumps includes the propensity for debris to flow into the pump from the bulk fluid tank. As debris flows into the pumps, the operation of the pumps may be impeded or stopped due to blocked areas of the pump.

### SUMMARY OF THE INVENTION

The above concerns are reconciled by a portable rotary or reciprocating positive displacement pump assembly. The pump assembly is air-driven only, and importantly, is not powered by a diesel engine as typically found in the art. The pump assembly is also equipped with a filter or strainer in the inlet to the pump, whereby all fluid being pumped passes through the strainer to ensure that no debris blocks or plugs the pump assembly. In operation, a hydrocarbon or bulk fluid tank fluidly communicates with the pump assembly to thereby quickly transfer fluid from one tank to another tank, receptacle, or reservoir. Accordingly, the release of hydrocarbons or fuel vapor into the area is substantially or completely eliminated.

### BRIEF DESCRIPTION OF THE DRAWINGS

Presently preferred embodiments of the invention are disclosed in the following description and in the accompanying drawings, wherein:

FIG. 1 illustrates a schematic view of a portable and mobile pump assembly, in accordance with the present invention.

FIG. 2 schematically illustrates a perspective and schematic view of a portable and mobile pump assembly of the present invention.

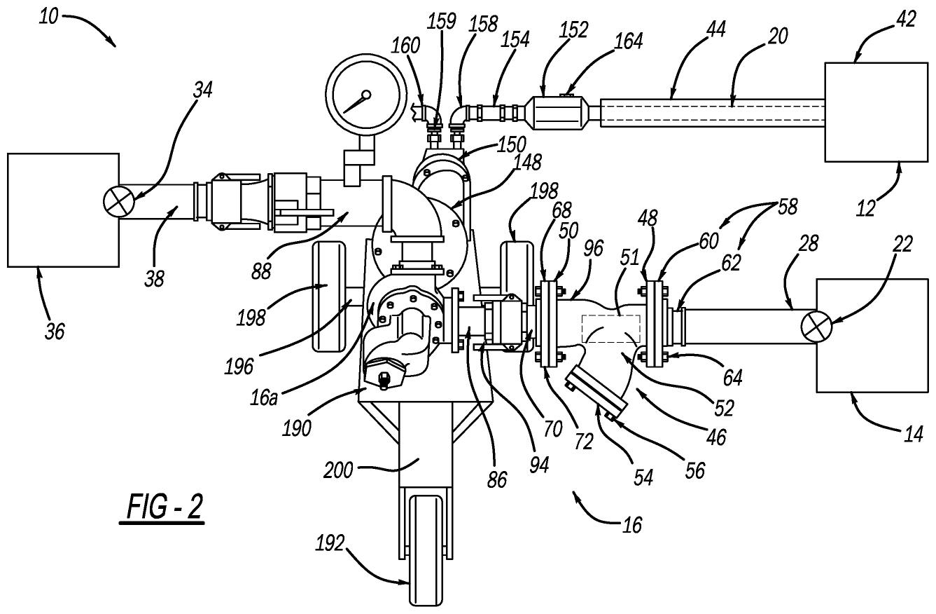

FIG. 3 schematically illustrates a fuel storage tank, in accordance with the present invention.

### DETAILED DESCRIPTION OF THE PREFERRED EMBODIMENTS

In accordance with the present invention, a liquid hydrocarbon transfer apparatus 10 includes an air compressor 12 at a location preferably spaced away from a storage tank 14 (that is, outside of the berm containing the storage tank 14), wherein the storage tank 14 contains a bulk fluid such as a hydrocarbon fuel, for example. A liquid hydrocarbon transfer pump assembly 16 is positioned adjacent to the storage tank 14, preferably somewhere within the berm containing the storage tank 14. The hydrocarbon transfer pump assembly 16 is operably connected to the air compressor 12 by an elongated air supply hose 20. The air compressor 12 is preferably located outside of the berm containing the storage tanks. The fuel transfer pump assembly 16 is connected to a first outlet valve 22 on the storage tank 14 by a primary flexible hydrocarbon discharge pipe. 28.

The hydrocarbon transfer pump assembly 16 may also be connected to a second outlet valve 24 by a secondary flexible hydrocarbon discharge pipe 30. As shown in the Figures, an inlet 15 contained within the hydrocarbon transfer pump assembly 16 may contain a plurality of sub-inlets (not shown) that each fluidly communicate with a flexible hydrocarbon discharge pipe such as first and second flexible hydrocarbon discharge pipes 28 and 30. A pump discharge port 32 is connected to a receiving valve 34 on a receiving storage tank 36 by a flexible hydrocarbon transfer pipe 38.

The exemplary air compressor 12 of one embodiment has a rated capacity of one hundred and eighty cubic feet per minute (cfm). The air compressor 12 may include an enclosed housing 42. The compressor housing 42 protects a drive unit and an air compressor 12 from rain and snow. The compressor drive unit that is employed may be an internal combustion engine or an electric motor, for example. Diesel engines are generally chosen for use in a tank farm and may be used to drive the compressor. A muffler 43 is typically used to reduce noise. The compressor housing 42 may be mounted on a trailer frame (not shown), for example. The trailer may be moveable by a motor vehicle. However, the housing 42 can be carried on a truck or in a van. The compressor housing 42 may also be provided on skids and unloaded onto the ground during use. In this embodiment, compressed air is provided from the compressor housing 42 through an insulated hose 44 with a 0.75 inch inside diameter. An insulated hose 44 is used to prevent condensation and freezing of water inside the insulated hose 44 during relatively cooler weather. Again, the air compressor 12 is preferably located outside of the tank berm, to enhance the safety of the operation.

The liquid hydrocarbon transfer pump assembly 16 includes a filter assembly 46 with a filter inlet flange 48 and a filter outlet flange 50. Both flanges 48 and 50, may as provided in this embodiment, have a four-inch diameter. In yet another embodiment, the flanges may both have a three-inch diameter. The inlet flange 48 is fixed to a filter housing 52. A filter 51 is removably contained within the filter housing 52, for straining or filtering the inlet flow of fuel or bulk fluid. The filter outlet flange 50 is also fixed to the filter housing 52, opposite to the inlet flange 48. A top cover 54 of the filter assembly 46 is clamped to the filter housing 52 by bolts 56. The filter assembly 46 and the filter 51 therefore separates materials mixed with the bulk fluid or hydrocarbons that might damage the fuel transfer pump assembly 16. The top cover 54 may be removed when necessary to clean the filter assembly 46. An inlet adapter 58 has an inlet adapter flange 60, and an inlet tube 62 fixed to the inlet adapter flange 60. Bolts 64 clamp the inlet adapter flange 60 to the filter inlet flange 48. An outlet adapter 66 has an outlet adapter flange 68, and an outlet tube 70 fixed to the outlet adapter flange 68. Bolts 72 clamp the outlet adapter flange 68 to the filter outlet flange 50. The inlet tube 62 and the outlet tube 70 may have tube passages with a three-inch or four-inch diameter, for example, or they may be varied depending on design criteria. The inlet tube 62 may, in a preferred embodiment, be coaxially aligned with the outlet tube 70.

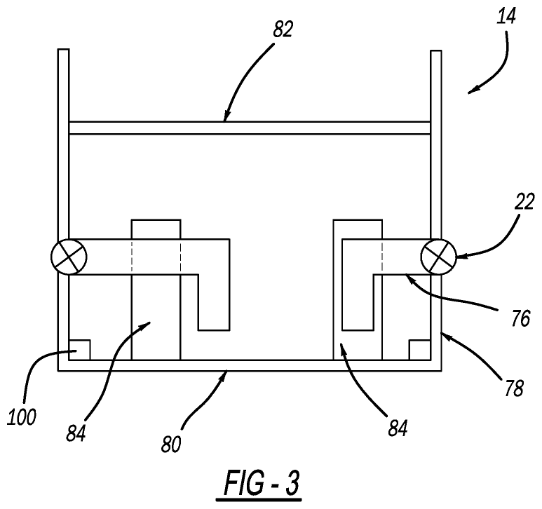

The inlet tube 62 of inlet adapter 58 is connected to the primary flexible fuel discharge pipe 28. As stated above, the discharge pipe 28 is connected to the first outlet valve 22. An exemplary first outlet passage 76 extends through a cylindrical wall 78 of the hydrocarbon storage tank 14, and is positioned above a tank horizontal floor 80 and below a tank roof 82. The first outlet valve 22 fluidly communicates with the first outlet passage 76 to facilitate flow out of the tank 14. A plurality of roof support blocks 84 are attached to the tank 14 and support the tank roof 82 when it is in a bottom-most position. As shown in FIG. 3, the support blocks 84 vertically extend above the outlet passage 76 to ensure that the tank roof 82 is suspended above all such outlet passages.

The first outlet valve 22 therefore fluidly communicates with the flexible hydrocarbon fuel discharge pipe 28 which in turn, fluidly communicates with the inlet tube 62 of the inlet adapter 58. The primary flexible hydrocarbon discharge pipe 28 has an inside diameter that is preferably the same as the inside diameter of the inlet tube 62 attached to the filter assembly 46. However, in yet another embodiment, the ratio of the diameter of the flexible discharge pipe 28 to the diameter of the inlet tube 62 may range from a 1.0 to 1.0 ratio to a 1.0 to 1.5 ratio. It is believed that this relationship advantageously assists the pump in more efficiently pumping the contents from a tank.

The hydrocarbon transfer pump assembly 16 has an inlet port 86 and an outlet port 88. The pump assembly 16 is a positive displacement pump selected from rotary or reciprocating power pumps. Importantly, an air-driven diaphragm positive displacement pump is not contemplated because of the disadvantages discussed above. Gorman Rupp, Roper, and Blackmer are exemplary manufacturers of positive displacement pumps that could also be used in accordance with the present invention. As shown in the Figures, the pump assembly 16 is actually a Roper positive displacement pump 16a combined with an exemplary Gast air pump 150 to drive the Roper positive displacement pump 16a. The inlet pump port 86 is connected to the pump housing 90 by bolts, for example. A cam lock quick connector 94, attached to the outlet tube 70 on the filter assembly 46, engages the inlet port 86 and locks the filter assembly 46 to the transfer pump assembly 16. The passage through the filter assembly 46 and into the transfer pump 16a has a preferred three-inch diameter that defines a passage 96. The primary flexible discharge pipe 28 preferably has a minimal length and a three-inch inside diameter. Hydrocarbon liquid in the storage tank 14 above the first outlet valve 22 provides pressure to force hydrocarbon liquid through the pipe 28 and toward the transfer pump assembly 16. In accordance with the present invention, the hydrocarbon transfer pump assembly 16 evacuates liquid from the storage tank 14 and synergistically operates with the potential energy of the hydrocarbon fuel flowing from the tank 14.

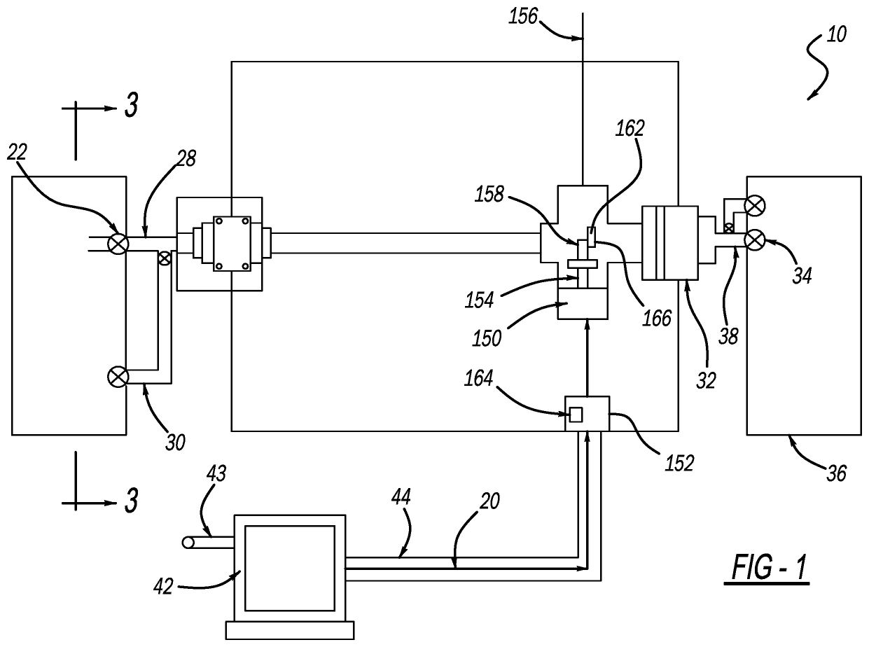

As shown in FIG. 1, a secondary flexible hydrocarbon discharge pipe 30 may be attached to a second outlet passage 98 through the tank cylindrical wall 78 of the hydrocarbon storage tank 14. The second outlet passage 98 may be in communication with a tank trough 100 adjacent to the cylindrical wall 78, and below the tank horizontal floor portion 80. The tank trough 100 encircles the horizontal floor portion 80 and forms a radially extending portion of the tank floor 80. The secondary flexible hydrocarbon discharge pipe 30 joins the primary flexible hydrocarbon discharge pipe 28 adjacent to the filter inlet flange 48. Flow of liquid hydrocarbon from two pipes 28 and 30 are joined at the filter inlet flange 48. The two joined pipes enhance the flow rate into the pump assembly 16. The hydrocarbon flexible transfer pipe 38 has another end attached to a receiving valve 34 on a receiving storage tank 36.

The flexible hydrocarbon transfer pipes 28, 30, and 38 are sized to accommodate the distance between the storage tank 14 and the receiving tank 36. Stated another way, in operation, the pump assembly 16 fluidly communicates with the inlet tank 14 and a receiving tank 36, thereby obviating the need to handle the pumping system and the bulk fluid more than once when transferring the bulk fluid from the inlet tank 14 and the receiving tank 36. Ideally, the pump assembly 16 is positioned between the holding tank 14 and the transfer or receiving tank 36, thereby reducing the transfer time of the fluid, and thereby only requiring one transfer of the fluid and resulting in minimal tank disturbance. Stated another way, with the present system, the fluid is transferred from tank to tank, as opposed to being transferred from a tank to a truck, then moved and transferred to a second tank. This mitigates the likelihood of a spill while also minimizing the amount of fuel fumes into the air within the berm. Another result is a relatively faster pumping rate than that presented by the standard methods, with less open hoses during transfer, and with considerably less stress on the transfer hoses. As such, the present invention provides a relative reduced down time for the tanks as the fuel is expeditiously transferred, as compared to known transfer systems.

Referring back to the hydrocarbon transfer pump assembly 16, the gear box 148 is attached to and driven by an air motor 150, which is driven by air supplied by the air compressor 12. As stated above the gear ratio may range from 3:1 to 4:1 in a preferred embodiment. It has been found that this gear ratio results in greater efficiency with the present inventive pumping system. Yet further, in addition to other benefits of the present system, the suction rate can be easily controlled to transfer the last few gallons more thoroughly through the emptying process, with considerably less vortex during transfer.

The air motor 150 in a preferred embodiment has a nine horse power rating, however, any suitable power may be applied. Air from the air compressor 12 in an enclosed compressor housing 42 supplies compressed air through an air supply hose 20 (to the air motor 150). The compressed air is received by an air dryer and oiler 152. Dried air and some oil is discharged through a dry air supply pipe 154. Separated water is drained through a drain pipe 156. The dry air supply pipe 154 is connected to air supply port 158 on the air motor 150. An air discharge port 159 on the air motor 150 receives a discharge pipe 160, wherein the discharge pipe 160 may include a muffler 162. Oil is inserted into the air dryer and oiler 152 through an oil reservoir cap 164. In yet another aspect of the invention, the oil may be mixed with a fuel antifreeze constituent, in effective amounts. For example, in a preferred embodiment, the oil/antifreeze ratio may range anywhere from 20:80 to 80:20 by volume, and is preferably at 50:50 by volume. It has been found that the freezing normally attendant during cold temperatures, with air-driven pumps such as a diaphragm pump, can be alleviated by using a fuel antifreeze combined with the oil in the oiler 152. Not only is there less stress on the pump, there is also less stress on the transfer hose as a result of mitigating the tendency for a freeze within the pump. A speed reduction gear box 148 attached to the air motor 150 drives a gear box drive shaft 146, wherein internal gears thereby drive the pump 16. In a preferred embodiment, the gear ratio of the gear box 148 may range from a three-to-one ratio to a four-to-one ratio.

A pipe 180 is attached to the pump outlet 88. A pressure gauge 182 is attached to the pipe 180 to measure the output pressure of liquid hydrocarbons at the outlet from the pump 16. A first ball valve (not shown) may be provided to be closeable to protect the pressure gauge 182 when a pressure measurement is not needed. A second ball valve (not shown) may be provided in the pipe 180 and would be openable to vent air from the system prior to the start of liquid hydrocarbon fuel transfer. The second ball valve would normally be closed.

The filter assembly 46, the positive displacement pump assembly 16 and the air motor 150 are mounted on a carriage frame 190. One or more wheels may support a front end of the frame 190. Accordingly, one end of the frame 190 may contain a single wheel 192, for steering the assembly 16. A second end of the frame 190 is supported by an axle 196 and two wheels 198. The entire frame 190 and attached components may be moved over a berm and up to a storage tank 14 that is to be emptied, by a small all-terrain vehicle or manually by one or two people depending on the terrain.

The air motor 150 and gear box 148 are mounted on a support beam 202 contained within the frame 190. A hitch assembly 200 may be attachable to a tow vehicle or pulled manually. The carriage frame 190 may be mounted on the two wheels 198, for example, or the carriage frame 190 may be mounted on two skids without wheels, or in lieu of wheels.

In yet another aspect of the invention, method of pumping a hydrocarbon fluid contains the following steps: providing an air-driven rotary or reciprocating positive displacement pump; providing an air-supply in fluid communication with the pump, to drive the pump; providing a hydrocarbon fluid to an inlet of the pump; and pumping the hydrocarbon fluid through the pump and out an outlet of the pump. The aforementioned method may further contain the additional step of: providing an oiler containing an oily composition in fluid communication with the air supply; and injecting the composition into the air supply to oil the air motor. Yet further, the aforementioned method may further contain the step of providing an oiler containing a composition containing an oil and a fuel antifreeze, in fluid communication with the air supply; and injecting the composition into the air-supply, to oil and de-ice the air motor. The fuel antifreeze may be any antifreeze or de-icing agent that is typically added to automotive vehicles, for example, to prevent icing of the fuel within a carburetor.

It should further be understood that the preceding is merely a detailed description of various embodiments of this invention and that numerous changes to the disclosed embodiments can be made in accordance with the disclosure herein without departing from the scope of the invention. The preceding description, therefore, is not meant to limit the scope of the invention. Rather, the scope of the invention is to be determined only by the appended claims and their equivalents.

What is claimed is:

1. A pump assembly comprising:
a rotary or reciprocating power positive displacement pump, said pump containing an inlet and an outlet;
an air motor adapted to be in fluid communication with an air supply and said positive displacement pump, for driving said pump; and
a filter member contained within said inlet, for straining a bulk fluid,
wherein said rotary or reciprocating power positive displacement pump is not a diaphragm pump.

2. The pump assembly of claim 1, wherein said pump is a rotary positive displacement pump containing drive gears, said drive gears sized to have a 3:1 to 4:1 size ratio relative to the respective diameter of each gear.

3. The pump assembly of claim 1 further comprising an oiler adapted to be in fluid communication with said air motor, for injecting oil into said air supply.

4. The pump assembly of claim 1 further comprising an oiler adapted to be in fluid communication with said air motor, for injecting an oil and/or fuel antifreeze mixture into said air supply.

5. The pump assembly of claim 1 further comprising:
a first inlet hose coupled to said inlet,
wherein said first inlet hose has a first diameter, and said inlet has a second diameter, and the size ratio of the first diameter to the second diameter ranges from 1:1 to 1:1.5.

6. The pump assembly of claim 5 further comprising a second inlet hose, wherein said inlet is coupled to said second inlet hose, and, wherein said second inlet hose has a third diameter, and the size ratio of the third diameter to the second diameter ranges from 1:1 to 1:1.5.

7. A pump assembly comprising:
a rotary or reciprocating power positive displacement pump, said pump containing an inlet and an outlet;
an air motor adapted to be in fluid communication with an air supply, for driving said pump;
an oiler adapted to be in fluid communication with said air supply; and
a filter member contained within said inlet, for straining a bulk fluid,
wherein said rotary or reciprocating power positive displacement pump is not a diaphragm pump.

8. The pump assembly of claim 7 containing a composition containing oil, said composition contained within said oiler and adapted to be in fluid communication with said air supply.

9. The pump assembly of claim 7 containing a composition containing oil and fuel antifreeze, said composition contained within said oiler and adapted to be in fluid communication with said air supply.

10. The pump assembly of claim 9 wherein said oil and fuel antifreeze are provided as a mixture at about a 50:50 volumetric percent ratio.

11. A method of pumping a hydrocarbon fluid comprising the following steps:
providing an air-driven rotary or reciprocating positive displacement pump;
providing an air-supply in fluid communication with the pump, to drive the pump;
providing a hydrocarbon fluid to an inlet of the pump; and
pumping the hydrocarbon fluid through the pump and out an outlet of the pump,
wherein said rotary or reciprocating power positive displacement pump is not a diaphragm pump.

12. The method of claim 11 further comprising the step of:
providing an oiler containing an oily composition, the oiler in fluid communication with the air-supply; and
injecting the oily composition into the air supply.

13. The method of claim 11 further comprising the step of:
providing an oiler containing a composition containing an oil and/or a fuel antifreeze, in fluid communication with the air-supply; and
injecting the composition into the air-supply.

14. The method of claim 11 further comprising the step of:
filtering the hydrocarbon fluid prior to pumping the hydrocarbon fluid through the pump.

15. A pump assembly incorporating the method of claim 11.
